(19) United States
(12) Patent Application Publication
(10) Pub. No.: US 2024/0314763 A1
(43) Pub. Date: Sep. 19, 2024

(54) PROTOCOL DATA UNIT (PDU) SESSION INFORMATION FOR DIFFERENT NETWORK SERVICE TYPES

(71) Applicant: ZTE Corporation, Shenzhen (CN)

(72) Inventors: Jie TAN, Shenzhen (CN); Bo DAI, Shenzhen (CN); Xiubin SHA, Shenzhen (CN); Ting LU, Shenzhen (CN); Yuan GAO, Shenzhen (CN)

(21) Appl. No.: 18/645,082

(22) Filed: Apr. 24, 2024

Related U.S. Application Data
(63) Continuation of application No. PCT/CN2022/080804, filed on Mar. 15, 2022.

(51) Int. Cl. H04W 72/12; H04J 3/06; H04L 1/1607; H04W 60/04; H04W 76/20

(52) U.S. Cl. CPC H04W 72/12; H04J 3/0661; H04L 1/1642; H04W 60/04; H04W 76/20

(57) ABSTRACT

Methods, apparatus, and systems that enable speedy and accurate scheduling of data transmission for various services types, such as deterministic networking services. In one example aspect, a method for wireless communication includes transmitting or receiving, by a base station, data packets with Protocol Data Unit (PDU) session information frames. The data packets are associated with one or more service types and each of the PDU session information frames includes a time stamp field. The method also includes scheduling, by the base station, subsequent data packets based on the time stamp field in at least one of the PDU session information frames.

### CROSS-REFERENCE TO RELATED APPLICATION

This application is a continuation and claims priority to International Application No. PCT International Application No. PCT/CN2022/080804, filed on Mar. 15, 2022, the disclosure of which is hereby incorporated by reference herein in its entirety.

### TECHNICAL FIELD

This patent document is directed generally to wireless communications.

### BACKGROUND

Mobile communication technologies are moving the world toward an increasingly connected and networked society. The rapid growth of mobile communications and advances in technology have led to greater demand for capacity and connectivity. Other aspects, such as energy consumption, device cost, spectral efficiency, and latency are also important to meeting the needs of various communication scenarios. Various techniques, including new ways to provide higher quality of service, longer battery life, and improved performance are being discussed.

### SUMMARY

This patent document describes, among other things, techniques that enable efficient and accurate scheduling of data transmissions for various services types, such as deterministic networking services that have specific Quality of Services (QoS) requirements.

In one example aspect, a method for wireless communication includes transmitting or receiving, by a base station, data packets with Protocol Data Unit (PDU) session information frames. The data packets are associated with one or more service types and each of the PDU session information frames includes a time stamp field. The method also includes scheduling, by the base station, subsequent data packets based on the time stamp field in at least one of the PDU session information frames.

In another example aspect, a method for wireless communication includes transmitting or receiving, by a base station, a data packet with a PDU session information frame. The PDU session information frame includes an indicator indicating a service type associated with the data packet and usage of a time stamp field included in the PDU session information frame. The method also includes scheduling, by the base station, subsequent data packets based on the time stamp field in the PDU session information frame.

In another example aspect, a method for wireless communication includes receiving or transmitting, by a user equipment, data packets with PDU session information frames. The data packets are associated with one or more service types and each of the PDU session information frames includes a time stamp field. The method also includes performing, by the user equipment, subsequent transmission or reception of data packets based on scheduling of the subsequent data packets using the time stamp field in at least one of the PDU session information frames.

In another example aspect, a method for wireless communication includes receiving or transmitting, by a user equipment, a data packet with a PDU session information frame. The PDU session information frame includes an indicator indicating a service type associated with the data packet and usage of a time stamp field included in the PDU session information frame. The method also includes performing, by the user equipment, subsequent transmission or reception of data packets based on scheduling of the subsequent data packets using the time stamp field in the PDU session information frame.

In another example aspect, a method for wireless communication includes receiving or transmitting, by a core network node, data packets with PDU session information frames. The data packets are associated with one or more service types, and each of the PDU session information frames includes a time stamp field.

In yet another example aspect, a method for wireless communication includes transmitting or receiving, by a core network node, a data packet with a PDU session information frame. The PDU session information frame includes an indicator indicating a service type associated with the data packet and usage of a time stamp field included in the PDU session information frame.

In another example aspect, a communication apparatus is disclosed. The apparatus includes a processor that is configured to implement an above-described method.

In yet another example aspect, a computer-program storage medium is disclosed. The computer-program storage medium includes code stored thereon. The code, when executed by a processor, causes the processor to implement a described method.

These, and other, aspects are described in the present document.

### BRIEF DESCRIPTION OF DRAWINGS

FIG. 1 illustrates overview of mobile deterministic networking potential solutions. Time synchronization between User Equipment (UE) and between UE and application server is one of important requirements in industry.

FIG. 2A is a flowchart representation of a method for wireless communication in accordance with one or more embodiments of the present technology.

FIG. 2B is a flowchart representation of another method for wireless communication in accordance with one or more embodiments of the present technology.

FIG. 3A is a flowchart representation of another method for wireless communication in accordance with one or more embodiments of the present technology.

FIG. 3B is a flowchart representation of another method for wireless communication in accordance with one or more embodiments of the present technology.

FIG. 4A is a flowchart representation of another method for wireless communication in accordance with one or more embodiments of the present technology.

FIG. 4B is a flowchart representation of yet another method for wireless communication in accordance with one or more embodiments of the present technology.

FIG. 5 illustrates an example PDU session information frame format for downlink traffic in accordance with one or more embodiments of the technology.

FIG. 6 illustrates another example PDU session information frame format for downlink traffic in accordance with one or more embodiments of the technology.

FIG. 7 illustrates yet another example PDU session information frame format for downlink traffic in accordance with one or more embodiments of the technology.

FIG. 8 illustrates an example sequence diagram for configuring predefined QoS flow characteristics in accordance with one or more embodiments of the present technology.

FIG. 9A illustrates an example sequence chart for the UE to report the current service type to the core network in accordance with one or more embodiments of the present technology.

FIG. 9B illustrates an example sequence chart for the base station to obtain the current service type in accordance with one or more embodiments of the present technology.

FIG. 10 shows an example of a wireless communication system where techniques in accordance with one or more embodiments of the present technology can be applied.

FIG. 11 is a block diagram representation of a portion of a radio station in accordance with one or more embodiments of the present technology can be applied.

### DETAILED DESCRIPTION

Section headings are used in the present document only to improve readability and do not limit scope of the disclosed embodiments and techniques in each section to only that section. Certain features are described using the example of Fifth Generation (5G) wireless protocol. However, applicability of the disclosed techniques is not limited to only 5G wireless systems.

The 5G wireless communication technology takes mobile broadband speeds to a whole new level, offering various classes of services that enhance user experience and foster the growth of other industries. For example, Massive Machine-Type Communication (mMTC) provides support for low powered, low cost, low-complexity devices with a battery life of up to ten years. The Enhanced Mobile Broadband (eMBB) is a class of service that targets peak download speeds of over 10 Gbps. The Ultra-Reliable Low Latency Communication (URLLC) service provides extremely low latencies for highly reliable connectivity. Under the framework of URLL, several emerging standards are defining the technology building-blocks needed for the delivery of reliable and predictable network services over deterministic networks.

Deterministic networks provide guaranteed latency on a per-deterministic-flow basis. The data traffic of each deterministic flow is delivered within a guaranteed bounded latency and low delay variation constraint, including key indicators such as bounded delay, jitter, packet loss rate, and precise positioning. Deterministic networks support a wide range of applications, each possibly having different QoS requirements. Deterministic networks can also have vastly different environments with different scaling, e.g., from the network in a single vehicle to a large, geographically dispersed network. Deterministic networks can provide deterministic service quality, flexibly switching between deterministic services and non-deterministic services, independently control of the deterministic service quality to fully empower industrial upgrades and machine communications.

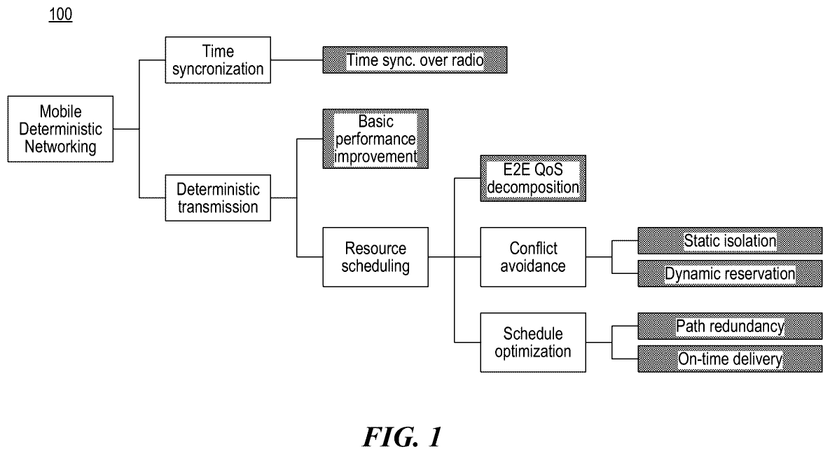

There are two ways to provide deterministic networking for QoS in 5G. One way is to configure an end-to-end deterministic networking slice ahead and assign it to the QoS flows during certain control procedures, such as PDU Session establishment. The other way is to initialize a qualified end-to-end path during control procedures. FIG. 1 illustrates overview of mobile deterministic networking potential solutions. Time synchronization between UE and between UE and application server is one of important requirements in industry. To enable support for service types such as deterministic network services, this patent document discloses techniques that can be implemented to provide speedy and accurate scheduling of data transmission for various services types. In particular, configuration information (e.g., predefined QoS characteristics and assistance/auxiliary information indicating transmission requirements) and timestamps of the data transmissions can be communicated between the UE, the base station, and the core network to facilitate accurate and timely scheduling and transmission of data.

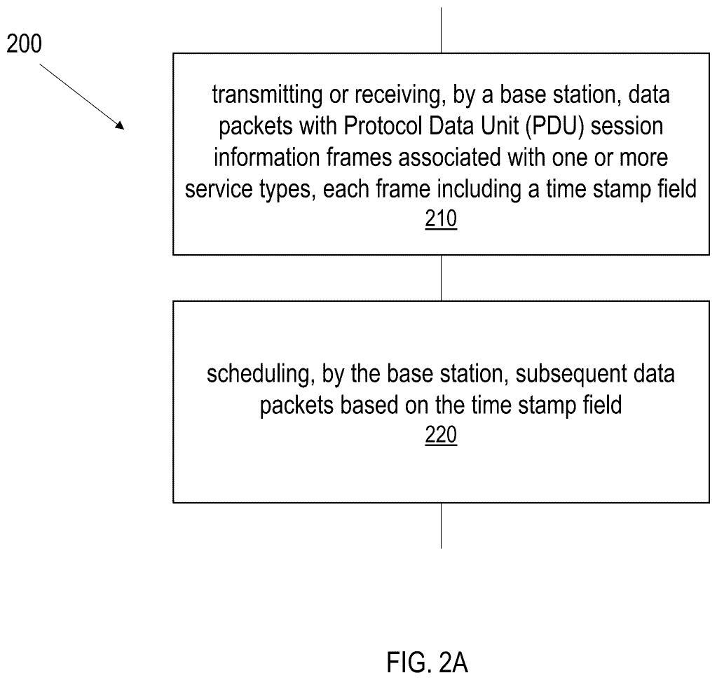

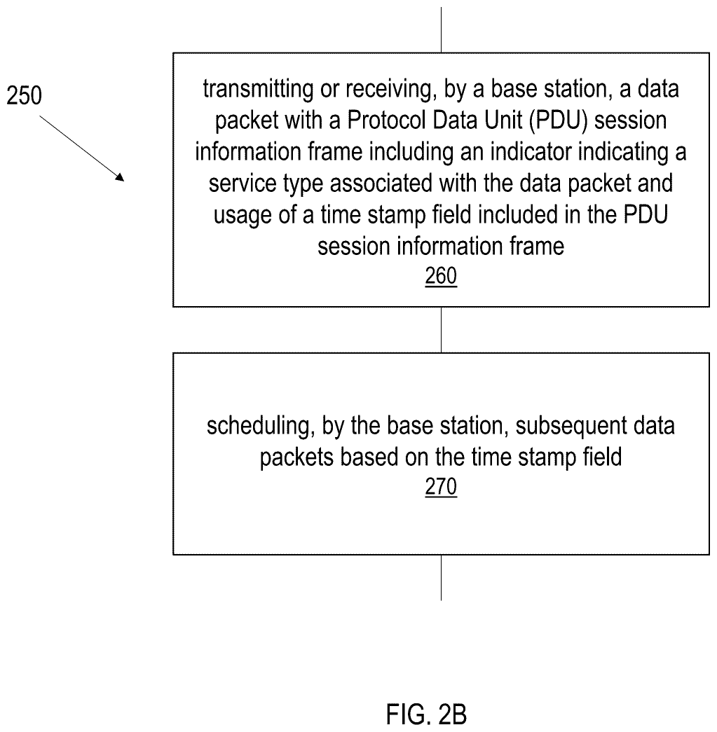

FIG. 2A is a flowchart representation of a method 200 for wireless communication in accordance with one or more embodiments of the present technology. The method 200 includes, at operation 210, transmitting or receiving, by a base station, data packets with Protocol Data Unit (PDU) session information frames. The data packets are associated with one or more service types (e.g., deterministic networking service type). Each of the PDU session information frames includes a time stamp field. The method 200 also includes, at operation 220, scheduling, by the base station, subsequent data packets based on the time stamp field in at least one of the PDU session information frames.

FIG. 2B is a flowchart representation of a method 250 for wireless communication in accordance with one or more embodiments of the present technology. The method 250 includes, at operation 260, transmitting or receiving, by a base station, a data packet with a Protocol Data Unit (PDU) session information frame. The PDU session information frame includes an indicator indicating a service type associated with the data packet and usage of a time stamp field included in the PDU session information frame. The method 250 also includes, at operation 270, scheduling, by the base station, subsequent data packets based on the time stamp field in the PDU session information frame. In some embodiments, the indicator includes a PDU type indicating a structure of the PDU session information frame that includes the time stamp field.

In some embodiments, the PDU session information frame includes at least one of: (1) a first indicator indicating an initial data packet for a same application message that includes multiple data packets, (2) a second indicator indicating a last data packet for the same application message that includes multiple data packets, (3) a third indicator indicating a number of the multiple data packets for the same application message, (4) a sequence number indicating a current data packet of the multiple data packets for the same application message, or (5) a sequence number distinguishing different application messages.

In some embodiments, the method includes receiving, by the base station, predefined Quality of Service (QoS) configuration for the service type in a PDU session establishment request or a PDU session modification request from a network node. In some embodiments, the scheduling comprises receiving, by the base station, assistance/auxiliary information from a user equipment. The assistance/auxiliary information comprises at least one of (1) a first delay budge for data packets at a service level, (2) a second delay budget for each data packet, (3) a third delay budget for data packets at the base station side, (4) an error rate for the data packets, (5) an estimated arrival time of a subsequent data packet, (6) a data size of the subsequent data packet, or (7) a current service type. In some embodiments, the assistance/auxiliary information is carried in a Non-Access Stratum (NAS) message from the user equipment to a core network node. The NAS message includes at least one of: service request information, uplink information transfer, or registration request information. The method further includes receiving, by the base station, a signaling message or data packets with PDU session information frames from the core network node indicating the current service type, the signaling message comprising at least one of (1) a PDU session resource setup request message, (2) a PDU session resource release command message, (3) a PDU session resource modification request message, (3) an initial context setup response message, (4) a UE context release command message, (5) a UE context modification request message, or (6) a handover request message.

In some embodiments, the assistance/auxiliary information is carried in UE assistance information or a Radio Resource Configuration (RRC) message, the RRC message comprising at least one of (1) an RRC establishment complete message, (2) an RRC reconfiguration complete message, (3) an RRC resume complete message, or (4) an RRC setup complete message. In some embodiments, the assistance/auxiliary information is carried in a Quality of Service (QoS) identifier, a service identifier, or a PDU session information.

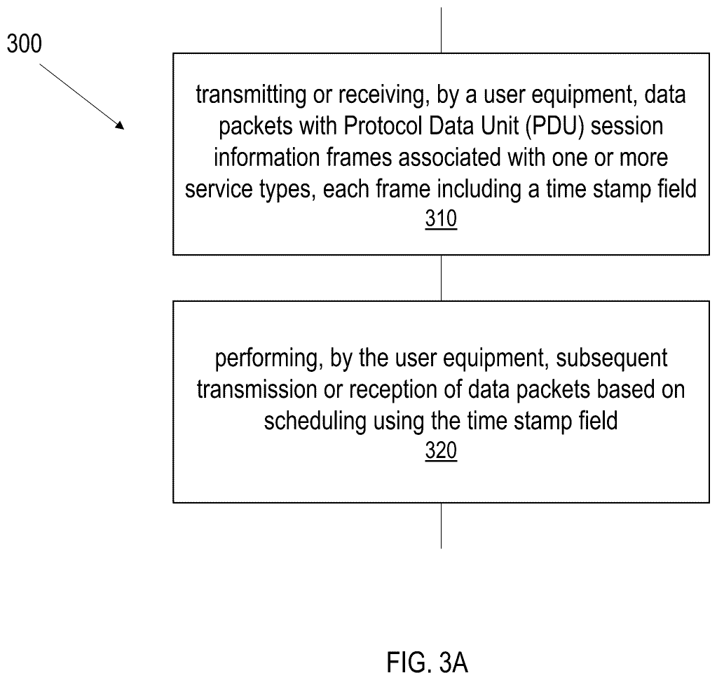

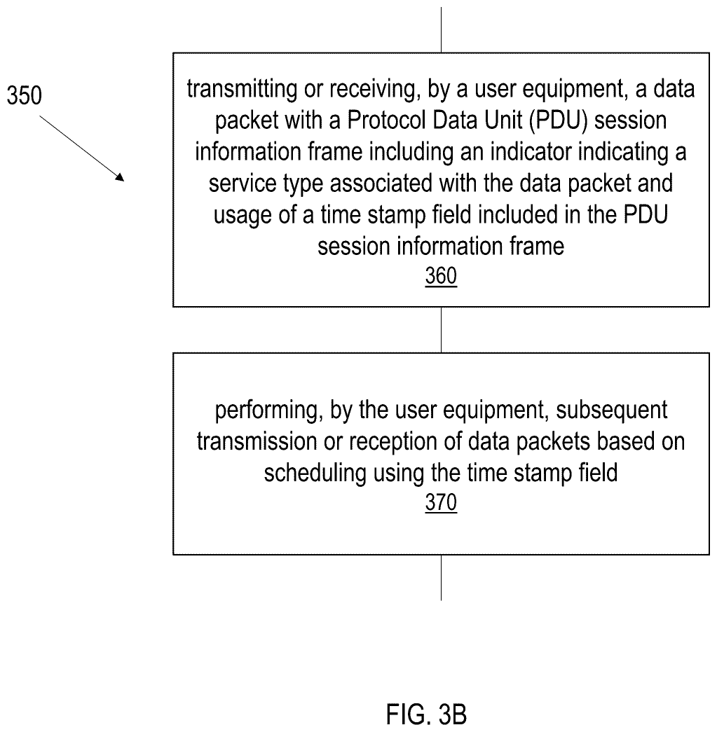

FIG. 3A is a flowchart representation of a method 300 for wireless communication in accordance with one or more embodiments of the present technology. The method 300 includes, at operation 310, receiving or transmitting, by a user equipment, data packets with Protocol Data Unit (PDU) session information frames. The data packets are associated with one or more service types (e.g., deterministic networking services), and each of the PDU session information frames includes a time stamp field. The method 300 includes, at operation 320, performing, by the user equipment, subsequent transmission or reception of data packets based on scheduling of the subsequent data packets using the time stamp field in at least one of the PDU session information frames.

FIG. 3B is a flowchart representation of a method 350 for wireless communication in accordance with one or more embodiments of the present technology. The method 350 includes, at operation 360, receiving or transmitting, by a user equipment, a data packet with a Protocol Data Unit (PDU) session information frame. The PDU session information frame includes an indicator indicating a service type associated with the data packet and usage of a time stamp field included in the PDU session information frame. The method 350 also includes, at operation 370, performing, by the user equipment, subsequent transmission or reception of data packets based on scheduling of the subsequent data packets using the time stamp field in the PDU session information frame. In some embodiments, the indicator includes a PDU type indicating a structure of the PDU session information frame that includes the time stamp field.

In some embodiments, the PDU session information frame includes at least one of: (1) a first indicator indicating an initial data packet for a same application message that includes multiple data packets, (2) a second indicator indicating a last data packet for the same application message that includes multiple data packets, (3) a third indicator indicating a number of the multiple data packets for the same application message, (4) a sequence number indicating a current data packet of the multiple data packets for the same application message, or (5) a sequence number distinguishing different application messages.

In some embodiments, the method includes receiving, by the user equipment, predefined Quality of Service (QoS) configuration for the service type in a Non-Access Stratum (NAS) message from a network node. In some embodiments, the method includes transmitting, by the user equipment, assistance/auxiliary information to the base station. The assistance/auxiliary information comprises at least one of (1) a first delay budge for data packets at a service level, (2) a second delay budget for each data packet, (3) a third delay budget for data packets the base station side, (4) an error rate for the data packets, (5) an estimated arrival time of a subsequent data packet, (6) a data size of the subsequent data packet, or (7) a current service type.

In some embodiments, the assistance/auxiliary information is carried in a Non-Access Stratum (NAS) message from the user equipment to a core network node. The NAS message comprises at least one of: service request information, uplink information transfer, or registration request information. A signaling message or data packets with PDU session information frames from the core network node indicates the current service type. The signaling message comprises at least one of (1) a PDU session resource setup request message, (2) a PDU session resource release command message, (3) a PDU session resource modification request message, (3) an initial context setup response message, (4) a UE context release command message, (5) a UE context modification request message, or (6) a handover request message.

In some embodiments, the assistance/auxiliary information is carried in UE assistance information or a Radio Resource Configuration (RRC) message, the RRC message comprising at least one of (1) an RRC establishment complete message, (2) an RRC reconfiguration complete message, (3) an RRC resume complete message, or (4) an RRC setup complete message. In some embodiments, the assistance information is carried in a Quality of Service (QoS) identifier, a service identifier, or a PDU session information.

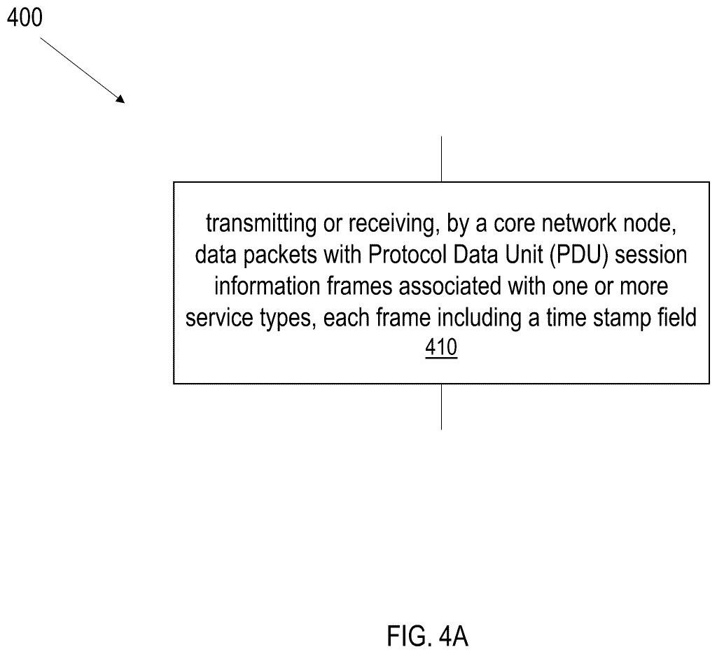

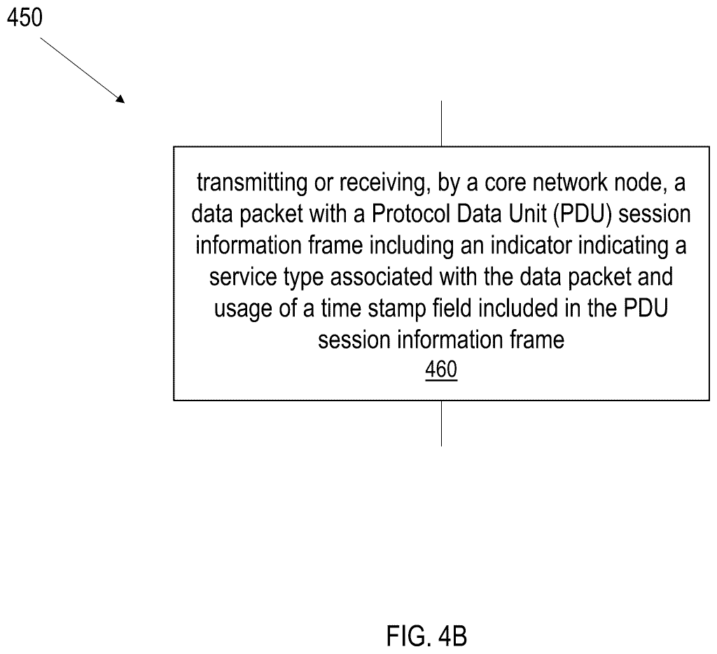

FIG. 4A is a flowchart representation of a method 400 for wireless communication in accordance with one or more embodiments of the present technology. The method 400 includes, receiving or transmitting, by a core network node, data packets with PDU session information frames. The data packets are associated with one or more service types, and each of the PDU session information frames includes a time stamp field.

FIG. 4B is a flowchart representation of a method 450 for wireless communication in accordance with one or more embodiments of the present technology. The method 450 includes, transmitting or receiving, by a core network node, a data packet with a Protocol Data Unit (PDU) session information frame. The PDU session information frame includes an indicator indicating a service type associated with the data packet and usage of a time stamp field included in the PDU session information frame. In some embodiments, the indicator includes a PDU type indicating a structure of the PDU session information frame that includes the time stamp field.

In some embodiments, the PDU session information frame includes at least one of: (1) a first indicator indicating an initial data packet for a same application message that includes multiple data packets, (2) a second indicator indicating a last data packet for the same application message that includes multiple data packets, (3) a third indicator indicating a number of the multiple data packets for the same application message, (4) a sequence number indicating a current data packet of the multiple data packets for the same application message, or (5) a sequence number distinguishing different application messages. In some embodiments, the method includes transmitting, by the core network node, assistance information to the base station, wherein the assistance information comprises at least one of (1) a first delay budge for data packets at a service level, (2) a second delay budget for each data packet, (3) a third delay budget for data packets at the base station side, (4) an error rate for the data packets, (5) an estimated arrival time of a subsequent data packet, (6) a data size of the subsequent data packet or (7) a current service type.

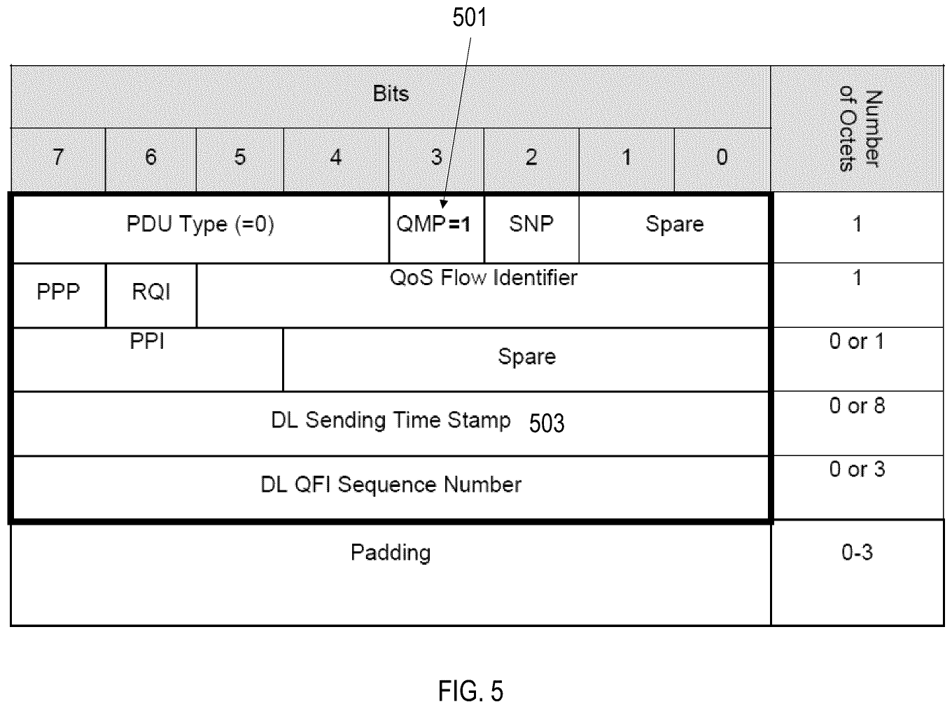

Some examples of the disclosed techniques shown in FIGS. 5-9B are further described in the following example Embodiments 1-3.

### Embodiment 1

Currently, the Third-Generation Partnership Project (3GPP) standard only allows the inclusion of timestamp information in the PDU session information for the purpose of QoS monitoring. The granularity and/or accuracy of the timestamps (e.g., 10 ns, 100 ns, etc.) is defined in the PDU session information format based on the accuracy of the reference clock provided by the core network. Timestamp information in data packets for different types of services can facilitate effective scheduling based on the service types (e.g., for deterministic networking). It is thus desirable to include timestamp information in data packets for multiple types of services. For example, the PDU session information format can include an indicator indicating that timestamp information is included for one or more types of services.

In some embodiments, all data packets in both the uplink and downlink directions can include timestamp information. In achieving so, the QoS Monitoring Packet (QMP) field can be changed to 1 for all data packets. FIG. 5 illustrates an example PDU session information frame format for downlink traffic in accordance with one or more embodiments of the technology. As shown in FIG. 5, the QMP field 501 is set to 1 for different types of services so that the timestamp information 503 can be included for all data packets. A similar format can be used for uplink traffic.

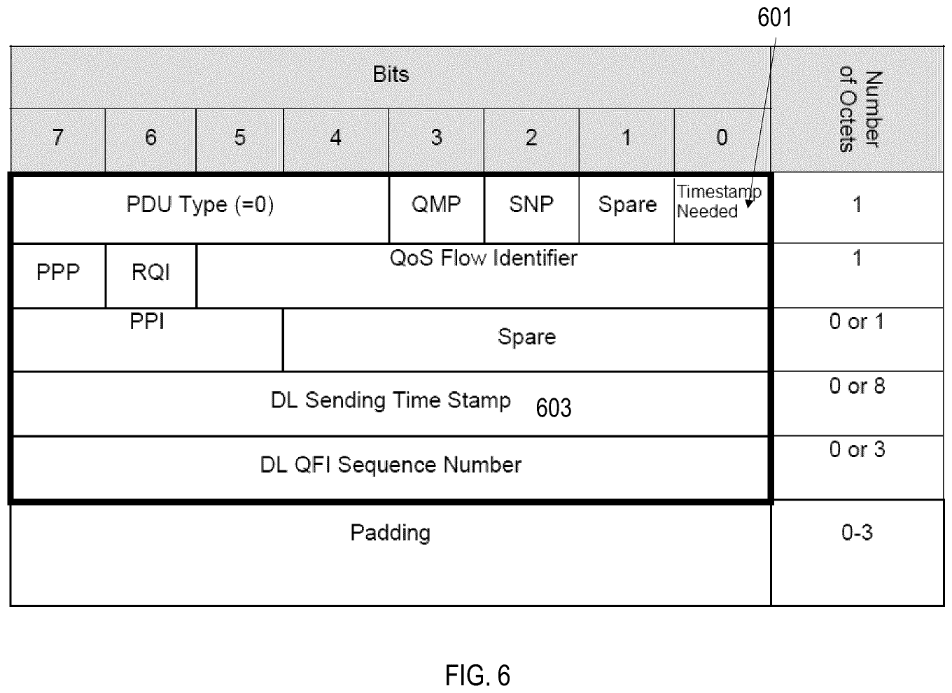

In some embodiments, one or more reserved bits can be used to indicate whether timestamp is needed for certain service type(s). For example, one or more reserved bits can be used to indicate whether the data packet is for deterministic networking service that requires timestamp information. Alternatively, or in addition, one or more reserved bits can directly indicate whether timestamp information is needed/included in the PDU session information. FIG. 6 illustrates another example PDU session information frame format for downlink traffic in accordance with one or more embodiments of the technology. In this example, the reserved bit 601 is used to indicate whether timestamp 603 is included in the PDU session information.

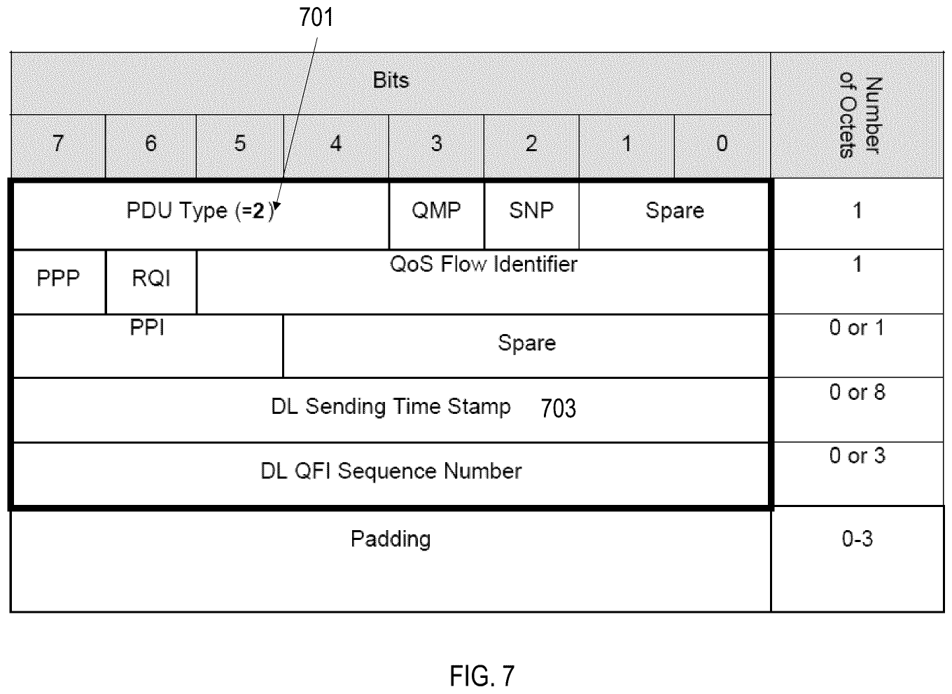

In some embodiments, additional PDU types can be defined to indicate the service type(s) associated with the data packets. FIG. 7 illustrates yet another example PDU session information frame format for downlink traffic in accordance with one or more embodiments of the technology. The PDU type 701 is in bit 4 to bit 7 in the first octet of the frame. Currently only two PDU types have been defined in the 3GPP standard: “0” for downlink PDU session information, and “1” for uplink PDU session information. The PDU type field can be extended to indicate various service types (e.g., eMBB, deterministic, etc.). For deterministic networking service, for example, the PDU type field 701 for the data packets can be set to 2, indicating that there is also corresponding timestamp information 703 included in the PDU session information frame.

In addition to the indicator indicating the service type(s) associated with the presence or absence of the timestamp information, the PDU session information format can further include information associated with application layer messages to the enable the base station to distinguish which PDU data packet(s) correspond to which application layer message(s). In some embodiments, the PDU session information format can further include at least one of the following types of information: an indicator indicating a first data packet of data packets corresponding to the same application layer message, an indicator indicating a last data packet of data packets corresponding to the same application layer message, the number of data packets corresponding to the same application layer message, a sequence number indicating that the data packet corresponds to a different application layer message, and/or a sequence number of the current data packet corresponding to the same application message.

When the base station is aware that multiple data packets correspond to the same application layer message, the timestamp information can be omitted for intermediate data packets so as to reduce signaling overhead. For example, the timestamp information can be included in the first data packet and/or the last data packet of the data packets that correspond to the same application layer message. As another example, the timestamp information is only included in the data packet that corresponds to a different application layer message as compared to the prior data packets.

### Embodiment 2

Certain service types can impose specific requirements on the resident time of data packets. For example, for deterministic networking services, there exists a resident time limitation for the data packets. In order to enable more efficient data transmissions, predefined QoS flow profile(s) or characteristic(s) can be configured when the PDU session is established or modified, thereby ensuring that the data traffic can satisfy the specific requirements associated with the service type(s).

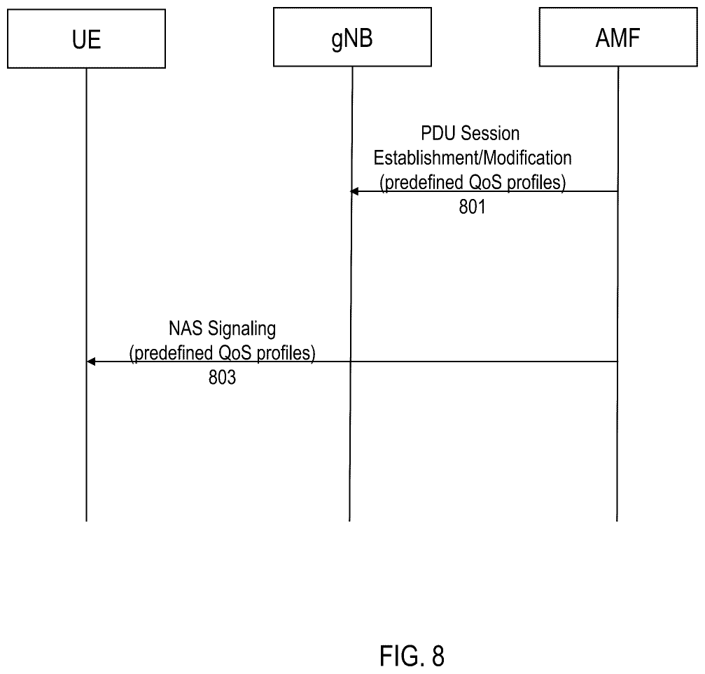

FIG. 8 illustrates an example sequence diagram for configuring predefined QoS flow characteristics in accordance with one or more embodiments of the present technology. In some embodiments, the accessibility and mobility function (AMF) can notify the gNB in PDU session establishment or modification (at operation 801) and/or notify the UE via Non-Access Stratum (NAS) signaling (at operation 803) of the predefined high-performance QoS flow characteristics (e.g., high priority levels, preemptive of service flows having certain priority level(s), low packet delay budgets, low packet error rates, high guaranteed streaming bit rates, high maximum streaming bit rate, etc.). In some embodiments, the high-performance QoS flow characteristics can be specified using one or more predefined 5G QoS Indicator (5QI) values.

### Embodiment 3

For uplink transmissions from the UE to the base station, it is necessary for the core network and the base station to identify the characteristics of the current service type of network communications.

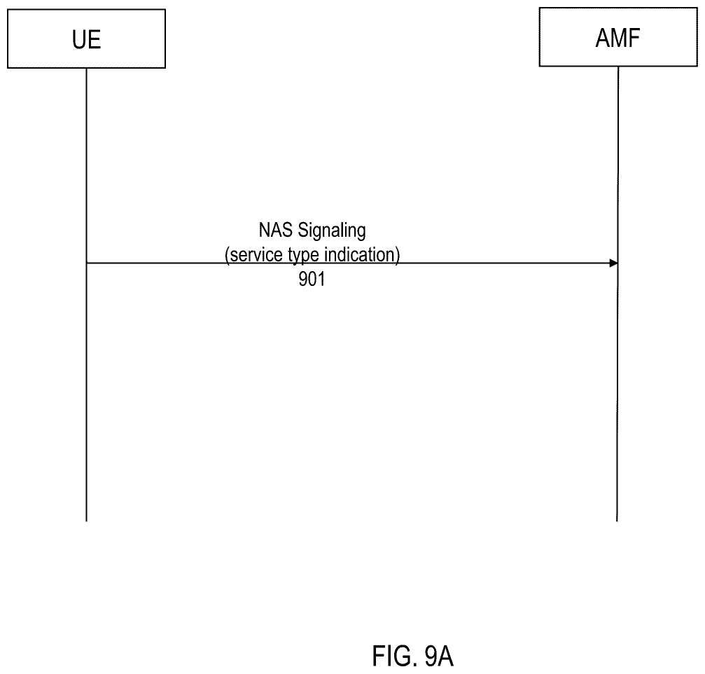

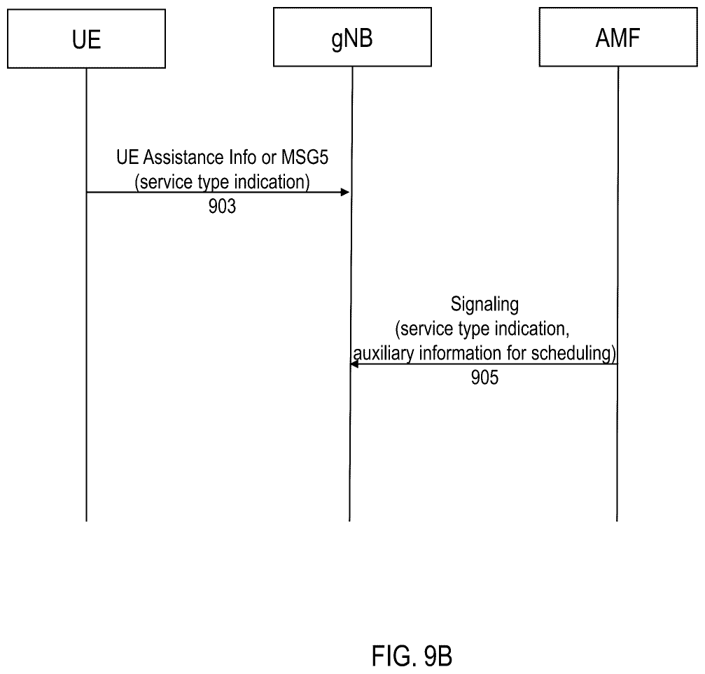

FIG. 9A illustrates an example sequence chart for the UE to report the current service type to the core network in accordance with one or more embodiments of the present technology. In this example, the UE can notify the AMF of the current service type through a NAS message. The NAS message includes at least one of the following: service request information, uplink transmission information (e.g., ULInformationTransfer), and/or registration request information.

FIG. 9B illustrates an example sequence chart for the base station to obtain the current service type in accordance with one or more embodiments of the present technology. In this example, the UE notifies the gNB of the current service type through UE Assistance Information or MSG5 in the Random Access (RACH) procedure. The UE Assistance Information or MSG5 includes at least one of the following: RRCReestablishmentComplete message, RRCReconfigurationComplete message, RRCResumeComplete message, and RRCSetupComplete message.

Furthermore, the core network (e.g., the AMF) can notify the gNB of the current service type and/or assistance/auxiliary information to assist the gNB in scheduling of the data packets. The core network can provide assistance/auxiliary information for data packets in communication through a newly added QoS identifier or service sensor, using downlink signaling to include the assistance/auxiliary information, and/or including the assistance/auxiliary information in the frame format of the PDU session information.

The assistance/auxiliary information includes at least one of: a data packet delay budget at a service level, a data packet delay budget at the data packet level, a data packet delay budget at the data packet level on the base station side, the error rate of the data packet, the arrival time of the next data packet, and/or the size of the next data packet. The packet delay budget in the assistance/auxiliary information can be defined as a value in units of time, and/or a level differentiated based on time granularity. For example, the packet delay budget can be included in the PDU session frame (e.g., using the reserved bits). In some embodiments, when the same application layer message corresponds to multiple data packets belonging to the same application layer information, the assistance/auxiliary information can be included in one or more selected data packets (e.g., the first data packet corresponding to the same application layer message, the last data packet corresponding to the same application layer message, etc.).

In some embodiments, the core network uses downlink signaling to indicate the assistance/auxiliary information. The downlink signaling can include at least one of: PDU Session Resource Setup Request message, PDU Session Resource Release Command message, PDU Session Resource Modify Request message, Initial Context Setup Response message, UE Context Release Command message, UE Context Modification Request message, and/or Handover Request message.

Some embodiments may preferably implement the following solutions. A set of preferred solutions may include the following (e.g., as described with reference to Embodiments 1-3).

1. A method for wireless communication, comprising transmitting or receiving, by a base station, data packets with Protocol Data Unit (PDU) session information frames, wherein the data packets are associated with one or more service types, and wherein each of the PDU session information frames includes a time stamp field; and scheduling, by the base station, subsequent data packets based on the time stamp field in at least one of the PDU session information frames.

2. A method for wireless communication, comprising: transmitting or receiving, by a base station, a data packet with a Protocol Data Unit (PDU) session information frame, and wherein the PDU session information frame includes an indicator indicating a service type associated with the data packet and usage of a time stamp field included in the PDU session information frame; and scheduling, by the base station, subsequent data packets based on the time stamp field in the PDU session information frame.

3. The method of solution 2, wherein the indicator includes a PDU type indicating a structure of the PDU session information frame that includes the time stamp field.

4. The method of any of solutions 1 to 3, wherein the PDU session information frame includes at least one of: (1) a first indicator indicating an initial data packet for a same application message that includes multiple data packets, (2) a second indicator indicating a last data packet for the same application message that includes multiple data packets, (3) a third indicator indicating a number of the multiple data packets for the same application message, (4) a sequence number indicating a current data packet of the multiple data packets for the same application message, or (5) a sequence number distinguishing different application messages.

5. The method of any of solutions 1 to 4, comprising: receiving, by the base station, predefined Quality of Service (QoS) configuration for the service type in a PDU session establishment request or a PDU session modification request from a network node.

6. The method of any of solutions 1 to 5, wherein the scheduling comprises: receiving, by the base station, assistance information from a user equipment, wherein the assistance information comprises at least one of (1) a first delay budge for data packets at a service level, (2) a second delay budget for each data packet, (3) a third delay budget for data packets at the base station side, (4) an error rate for the data packets, (5) an estimated arrival time of a subsequent data packet, (6) a data size of the subsequent data packet, or (7) a current service type.

7. The method of solution 6, wherein the assistance information is carried in a Non-Access Stratum (NAS) message from the user equipment to a core network node, the NAS message comprising at least one of: service request information, uplink information transfer, or registration request information, wherein the method further comprises: receiving, by the base station, a signaling message or data packets with PDU session information frames from the core network node indicating the current service type, the signaling message comprising at least one of (1) a PDU session resource setup request message, (2) a PDU session resource release command message, (3) a PDU session resource modification request message, (3) an initial context setup response message, (4) a UE context release command message, (5) a UE context modification request message, or (6) a handover request message.

8. The method of solution 6, wherein the assistance information is carried in UE assistance information or a Radio Resource Configuration (RRC) message, the RRC message comprising at least one of (1) an RRC establishment complete message, (2) an RRC reconfiguration complete message, (3) an RRC resume complete message, or (4) an RRC setup complete message.

9. The method of solution 8, wherein the assistance information is carried in a Quality of Service (QoS) identifier, a service identifier, or a PDU session information.

10. A method for wireless communication, comprising: receiving or transmitting, by a user equipment, data packets with Protocol Data Unit (PDU) session information frames, wherein the data packets are associated with one or more service types, and wherein each of the PDU session information frames includes a time stamp field; and performing, by the user equipment, subsequent transmission or reception of data packets based on scheduling of the subsequent data packets using the time stamp field in at least one of the PDU session information frames.

11. A method for wireless communication, comprising: receiving or transmitting, by a user equipment, a data packet with a Protocol Data Unit (PDU) session information frame, wherein the PDU session information frame includes an indicator indicating a service type associated with the data packet and usage of a time stamp field included in the PDU session information frame; and performing, by the user equipment, subsequent transmission or reception of data packets based on scheduling of the subsequent data packets using the time stamp field in the PDU session information frame.

12. The method of solution 11, wherein the indicator includes a PDU type indicating a structure of the PDU session information frame that includes the time stamp field.

13. The method of any of solutions 10 to 12, wherein the PDU session information frame includes at least one of: (1) a first indicator indicating an initial data packet for a same application message that includes multiple data packets, (2) a second indicator indicating a last data packet for the same application message that includes multiple data packets, (3) a third indicator indicating a number of the multiple data packets for the same application message, (4) a sequence number indicating a current data packet of the multiple data packets for the same application message, or (5) a sequence number distinguishing different application messages.

14. The method of any of solutions 10 to 13, comprising: receiving, by the user equipment, predefined Quality of Service (QoS) configuration for the service type in a Non-Access Stratum (NAS) message from a network node.

15. The method of any of solutions 10 to 14, comprising: transmitting, by the user equipment, assistance information to the base station, wherein the assistance information comprises at least one of (1) a first delay budge for data packets at a service level, (2) a second delay budget for each data packet, (3) a third delay budget for data packets at the base station side, (4) an error rate for the data packets, (5) an estimated arrival time of a subsequent data packet, (6) a data size of the subsequent data packet, or (7) a current service type.

16. The method of solution 15, wherein the assistance information is carried in a Non-Access Stratum (NAS) message from the user equipment to a core network node, the NAS message comprising at least one of: service request information, uplink information transfer, or registration request information, and wherein a signaling message or data packets with PDU session information frames from the core network node indicates the current service type, the signaling message comprising at least one of (1) a PDU session resource setup request message, (2) a PDU session resource release command message, (3) a PDU session resource modification request message, (3) an initial context setup response message, (4) a UE context release command message, (5) a UE context modification request message, or (6) a handover request message.

17. The method of solution 16, wherein the assistance information is carried in UE assistance information or a Radio Resource Configuration (RRC) message, the RRC message comprising at least one of (1) an RRC establishment complete message, (2) an RRC reconfiguration complete message, (3) an RRC resume complete message, or (4) an RRC setup complete message.

18. The method of solution 17, wherein the assistance information is carried in a Quality of Service (QoS) identifier, a service identifier, or a PDU session information.

19. A method for wireless communication, comprising: receiving or transmitting, by a core network node, data packets with PDU session information frames, wherein the data packets are associated with one or more service types, and wherein each of the PDU session information frames includes a time stamp field.

20. A method for wireless communication, comprising: transmitting or receiving, by a core network node, a data packet with a Protocol Data Unit (PDU) session information frame, and wherein the PDU session information frame includes an indicator indicating a service type associated with the data packet and usage of a time stamp field included in the PDU session information frame.

21. The method of solution 20, wherein the indicator includes a PDU type indicating a structure of the PDU session information frame that includes the time stamp field.

22. The method of any of solutions 19 to 21, wherein the PDU session information frame includes at least one of: (1) a first indicator indicating an initial data packet for a same application message that includes multiple data packets, (2) a second indicator indicating a last data packet for the same application message that includes multiple data packets, (3) a third indicator indicating a number of the multiple data packets for the same application message, (4) a sequence number indicating a current data packet of the multiple data packets for the same application message, or (5) a sequence number distinguishing different application messages.

23. The method of any of solutions 19 to 22, comprising: transmitting, by the core network node, assistance information to the base station, wherein the assistance information comprises at least one of (1) a first delay budge for data packets at a service level, (2) a second delay budget for each data packet, (3) a third delay budget for data packets at the base station side, (4) an error rate for the data packets, (5) an estimated arrival time of a subsequent data packet, (6) a data size of the subsequent data packet or (7) a current service type.

24. A communication apparatus, comprising a processor configured to implement a method recited in any one or more of solutions 1 to 23.

25. A computer program product having code stored thereon, the code, when executed by a processor, causing the processor to implement a method recited in any one or more of solutions 1 to 23.

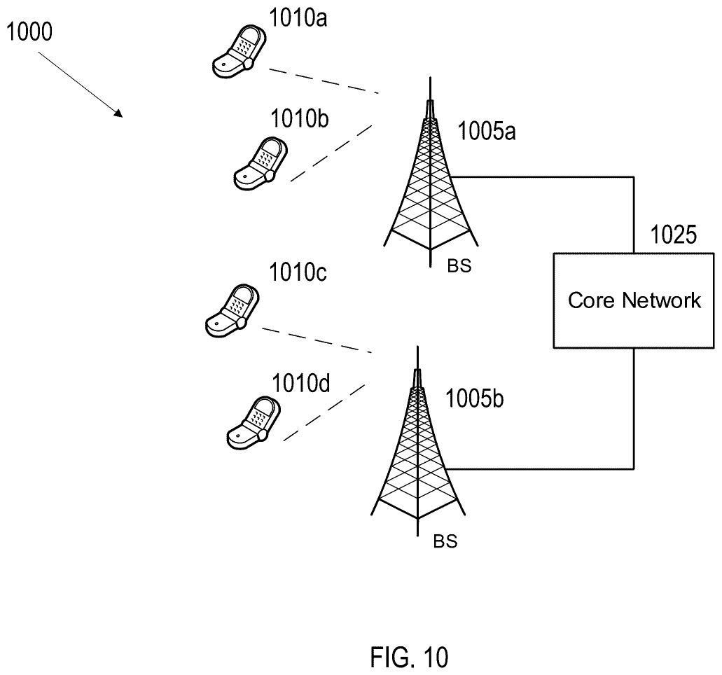

FIG. 10 shows an example of a wireless communication system 1000 where techniques in accordance with one or more embodiments of the present technology can be applied. A wireless communication system 1000 can include one or more base stations (BSs) 1005a, 1005b, one or more wireless devices (or UEs) 1010a, 1010b, 1010c, 1010d, and a core network 1025. A base station 1005a, 1005b can provide wireless service to user devices 1010a, 1010b, 1010c and 1010d in one or more wireless sectors. In some implementations, a base station 1005a, 1005b includes directional antennas to produce two or more directional beams to provide wireless coverage in different sectors. The core network 1025 can communicate with one or more base stations 1005a, 1005b. The core network 1025 provides connectivity with other wireless communication systems and wired communication systems. The core network may include one or more service subscription databases to store information related to the subscribed user devices 1010a, 1010b, 1010c, and 1010d. A first base station 1005a can provide wireless service based on a first radio access technology, whereas a second base station 1005b can provide wireless service based on a second radio access technology. The base stations 1005a and 1005b may be co-located or may be separately installed in the field according to the deployment scenario. The user devices 1010a, 1010b, 1010c, and 1010d can support multiple different radio access technologies. The techniques and embodiments described in the present document may be implemented by the base stations of wireless devices described in the present document.

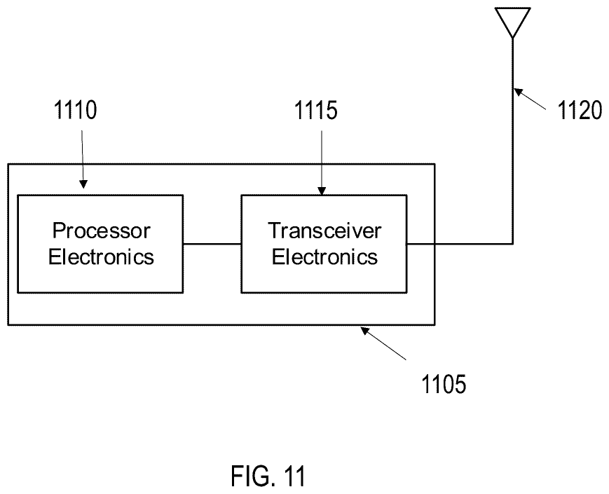

FIG. 11 is a block diagram representation of a portion of a radio station in accordance with one or more embodiments of the present technology can be applied. A radio station 1105 such as a network node, a base station, or a wireless device (or a user equipment, UE) can include processor electronics 1110 such as a microprocessor that implements one or more of the wireless techniques presented in this document. The radio station 1105 can include transceiver electronics 1115 to send and/or receive wireless signals over one or more communication interfaces such as antenna 1120. The radio station 1105 can include other communication interfaces for transmitting and receiving data. Radio station 1105 can include one or more memories (not explicitly shown) configured to store information such as data and/or instructions. In some implementations, the processor electronics 1110 can include at least a portion of the transceiver electronics 1115. In some embodiments, at least some of the disclosed techniques, modules or functions are implemented using the radio station 1105. In some embodiments, the radio station 1105 may be configured to perform the methods described herein.

It will be appreciated that the present document discloses techniques that can be embodied in various embodiments to facilitate the efficient scheduling and accurate transmission of data packets for service types such as the deterministic networking services. The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

What is claimed is:

1. A method for wireless communication, comprising:
transmitting or receiving, by a base station, a data packet with a Protocol Data Unit (PDU) session information frame, and wherein the PDU session information frame includes a time stamp field and an indicator, the indicator indicating a service type associated with the data packet and usage of the time stamp field, the indicator further including a PDU type indicating a structure of the PDU session information frame that includes the time stamp field; and
scheduling, by the base station, subsequent data packets based on the time stamp field in the PDU session information frame.

2. The method of claim 1, wherein the PDU session information frame includes at least one of: (1) a first indicator indicating an initial data packet for a same application message that includes multiple data packets, (2) a second indicator indicating a last data packet for the same application message that includes the multiple data packets, (3) a third indicator indicating a number of the multiple data packets for the same application message, (4) a sequence number indicating a current data packet of the multiple data packets for the same application message, or (5) a sequence number distinguishing different application messages.

3. The method of claim 1, comprising:
receiving, by the base station, predefined Quality of Service (QoS) configuration for the service type in a PDU session establishment request or a PDU session modification request from a network node.

4. The method of claim 1, wherein the scheduling comprises:
receiving, by the base station, assistance information from a user equipment, wherein the assistance information comprises at least one of (1) a first delay budge for data packets at a service level, (2) a second delay budget for each data packet, (3) a third delay budget for data packets at the base station, (4) an error rate for the data packets, (5) an estimated arrival time of a subsequent data packet, (6) a data size of the subsequent data packet, or (7) a current service type.

5. The method of claim 4, wherein the assistance information is carried in a Non-Access Stratum (NAS) message from the user equipment to a core network node, the NAS message comprising at least one of: service request information, uplink information transfer, or registration request information, wherein the method further comprises:
receiving, by the base station, a signaling message or data packets with PDU session information frames from the core network node indicating the current service type, the signaling message comprising at least one of (1) a PDU session resource setup request message, (2) a PDU session resource release command message, (3) a PDU session resource modification request message, (3) an initial context setup response message, (4) a UE context release command message, (5) a UE context modification request message, or (6) a handover request message, wherein the assistance information is carried in user equipment assistance information or a Radio Resource Configuration (RRC) message, the RRC message comprising at least one of (1) an RRC establishment complete message, (2) an RRC reconfiguration complete message, (3) an RRC resume complete message, or (4) an RRC setup complete message, and wherein the assistance information is carried in a Quality of Service (QoS) identifier, a service identifier, or a PDU session information.

6. A method for wireless communication, comprising:
receiving or transmitting, by a user equipment, a data packet with a Protocol Data Unit (PDU) session information frame, wherein the PDU session information frame includes a time stamp field and an indicator, the indicator indicating a service type associated with the data packet and usage of the time stamp field included in the PDU session information frame, the indicator further including a PDU type indicating a structure of the PDU session information frame that includes the time stamp field; and
performing, by the user equipment, subsequent transmission or reception of data packets based on scheduling of the subsequent data packets using the time stamp field in the PDU session information frame.

7. The method of claim 6, wherein the PDU session information frame includes at least one of: (1) a first indicator indicating an initial data packet for a same application message that includes multiple data packets, (2) a second indicator indicating a last data packet for the same application message that includes the multiple data packets, (3) a third indicator indicating a number of the multiple data packets for the same application message, (4) a sequence number indicating a current data packet of the multiple data packets for the same application message, or (5) a sequence number distinguishing different application messages.

8. The method of claim 6, comprising:
receiving, by the user equipment, predefined Quality of Service (QoS) configuration for the service type in a Non-Access Stratum (NAS) message from a network node.

9. The method of claim 6, comprising:
transmitting, by the user equipment, assistance information to a base station, wherein the assistance information comprises at least one of (1) a first delay budge for data packets at a service level, (2) a second delay budget for each data packet, (3) a third delay budget for data packets at the base station, (4) an error rate for the data packets, (5) an estimated arrival time of a subsequent data packet, (6) a data size of the subsequent data packet, or (7) a current service type.

10. The method of claim 9, wherein the assistance information is carried in a Non-Access Stratum (NAS) message from the user equipment to a core network node, the NAS message comprising at least one of: service request information, uplink information transfer, or registration request information, and wherein a signaling message or data packets with PDU session information frames from the core network node indicates the current service type, the signaling message comprising at least one of (1) a PDU session resource setup request message, (2) a PDU session resource release command message, (3) a PDU session resource modification request message, (3) an initial context setup response message, (4) a UE context release command message, (5) a UE context modification request message, or (6) a handover request message, wherein the assistance information is carried in UE assistance information or a Radio Resource Configuration (RRC) message, the RRC message comprising at least one of (1) an RRC establishment complete message, (2) an RRC reconfiguration complete message, (3) an RRC resume complete message, or (4) an RRC setup complete message, and wherein the assistance information is carried in a Quality of Service (QoS) identifier, a service identifier, or a PDU session information.

11. A communication apparatus, comprising:
transceiver electronics configured to transmit or receive a data packet with a Protocol Data Unit (PDU) session information frame, and wherein the PDU session information frame includes a time stamp field and an indicator, the indicator indicating a service type associated with the data packet and usage of the time stamp field, the indicator further including a PDU type indicating a structure of the PDU session information frame that includes the time stamp field; and
at least a processor configured to schedule subsequent data packets based on the time stamp field in the PDU session information frame.

12. The communication apparatus of claim 11, wherein the PDU session information frame includes at least one of: (1) a first indicator indicating an initial data packet for a same application message that includes multiple data packets, (2) a second indicator indicating a last data packet for the same application message that includes the multiple data packets, (3) a third indicator indicating a number of the multiple data packets for the same application message, (4) a sequence number indicating a current data packet of the multiple data packets for the same application message, or (5) a sequence number distinguishing different application messages.

13. The communication apparatus of claim 11, wherein the transceiver electronics are configured to receive predefined Quality of Service (QoS) configuration for the service type in a PDU session establishment request or a PDU session modification request from a network node.

14. The communication apparatus of claim 11, wherein the transceiver electronics are configured to receive assistance information from a user equipment, wherein the assistance information comprises at least one of (1) a first delay budge for data packets at a service level, (2) a second delay budget for each data packet, (3) a third delay budget for data packets at the communication apparatus, (4) an error rate for the data packets, (5) an estimated arrival time of a subsequent data packet, (6) a data size of the subsequent data packet, or (7) a current service type.

15. The communication apparatus of claim 14, wherein the assistance information is carried in a Non-Access Stratum (NAS) message from the user equipment to a core network node, the NAS message comprising at least one of: service request information, uplink information transfer, or registration request information, wherein the transceiver electronics are configured to:
receive a signaling message or data packets with PDU session information frames from the core network node indicating the current service type, the signaling message comprising at least one of (1) a PDU session resource setup request message, (2) a PDU session resource release command message, (3) a PDU session resource modification request message, (3) an initial context setup response message, (4) a UE context release command message, (5) a UE context modification request message, or (6) a handover request message, wherein the assistance information is carried in user equipment assistance information or a Radio Resource Configuration (RRC) message, the RRC message comprising at least one of (1) an RRC establishment complete message, (2) an RRC reconfiguration complete message, (3) an RRC resume complete message, or (4) an RRC setup complete message, and wherein the assistance information is carried in a Quality of Service (QoS) identifier, a service identifier, or a PDU session information.

16. A communication apparatus, comprising transceiver electronics configured to:
receive or transmit a data packet with a Protocol Data Unit (PDU) session information frame, wherein the PDU session information frame includes a time stamp field and an indicator, the indicator indicating a service type associated with the data packet and usage of a time stamp field included in the PDU session information frame, the indicator further including a PDU type indicating a structure of the PDU session information frame that includes the time stamp field; and
perform subsequent transmission or reception of data packets based on scheduling of the subsequent data packets using the time stamp field in the PDU session information frame.

17. The communication apparatus of claim 16, wherein the PDU session information frame includes at least one of: (1) a first indicator indicating an initial data packet for a same application message that includes multiple data packets, (2) a second indicator indicating a last data packet for the same application message that includes the multiple data packets, (3) a third indicator indicating a number of the multiple data packets for the same application message, (4) a sequence number indicating a current data packet of the multiple data packets for the same application message, or (5) a sequence number distinguishing different application messages.

18. The communication apparatus of claim 16, wherein the transceiver electronics are configured to:
receive predefined Quality of Service (QoS) configuration for the service type in a Non-Access Stratum (NAS) message from a network node.

19. The communication apparatus of claim 16, wherein the transceiver electronics are configured to:
transmit assistance information to a base station, wherein the assistance information comprises at least one of (1) a first delay budge for data packets at a service level, (2) a second delay budget for each data packet, (3) a third delay budget for data packets at the base station, (4) an error rate for the data packets, (5) an estimated arrival time of a subsequent data packet, (6) a data size of the subsequent data packet, or (7) a current service type.

20. The communication apparatus of claim 19, wherein the assistance information is carried in a Non-Access Stratum (NAS) message from the communication apparatus to a core network node, the NAS message comprising at least one of: service request information, uplink information transfer, or registration request information, and wherein a signaling message or data packets with PDU session information frames from the core network node indicates the current service type, the signaling message comprising at least one of (1) a PDU session resource setup request message, (2) a PDU session resource release command message, (3) a PDU session resource modification request message, (3) an initial context setup response message, (4) a UE context release command message, (5) a UE context modification request message, or (6) a handover request message, wherein the assistance information is carried in UE assistance information or a Radio Resource Configuration (RRC) message, the RRC message comprising at least one of (1) an RRC establishment complete message, (2) an RRC reconfiguration complete message, (3) an RRC resume complete message, or (4) an RRC setup complete message, and wherein the assistance information is carried in a Quality of Service (QoS) identifier, a service identifier, or a PDU session information.
